(19) United States
(12) Patent Application Publication
(10) Pub. No.: US 2018/0281754 A1
(43) Pub. Date: Oct. 4, 2018

(54) TIRE INFLATOR HEADS AND BICYCLE PUMP INCORPORATING SAME

(71) Applicant: Jonathan Staples, SQUAMISH (CA)

(72) Inventor: Jonathan Staples, SQUAMISH (CA)

(21) Appl. No.: 15/472,074

(22) Filed: Mar. 28, 2017

(51) Int. Cl. B60S 5/04; F04B 33/00; F04B 39/10

(52) U.S. Cl. CPC B60S 5/043; F04B 33/005; B60S 5/04; B60Y 2200/13; F04B 39/10

(57) ABSTRACT

An inflator head and a bicycle pump incorporating the inflator head are provided. The inflator head is operable with the pump for manually inflating a tire and is removable from the pump for inflating the tire using a compressed gas cartridge. The inflator head includes a body having a first aperture for engaging the compressed gas cartridge at a first end and a second aperture for engaging a tire valve at a second end opposed to the first end. A piercing member is disposed at the first aperture and housed in a piercing member channel fluidly connected to the first aperture. One or more gas flow channels are defined by the body and fluidly connect the first aperture to a gas flow passageway. The gas flow passageway fluidly connects the one or more gas flow channels and the second aperture.

### TECHNICAL FIELD

The present invention relates to tire inflator heads and, more specifically, to bicycle tire inflator heads and a bicycle pump incorporating same. The inflator heads double as a pump inflator head for use with a hand-actuated bicycle pump and a compressed gas inflator head for use with a compressed gas cartridge.

### BACKGROUND

A typical bicycle pump functions via a hand-operated piston. During an up-stroke, the piston draws external air through a one-way valve into a pump body. During a down-stroke, the piston displaces the air in the pump body into a bicycle tire.

Due to the size and weight of the pump, many bicyclists opt to carry other lighter and more compact means to inflate a flat tire. Compressed gas (e.g. carbon dioxide (CO₂)) cartridges are commonly used. To inflate a tire, the cartridge must be used with an inflator head. The inflator head is used to pierce a membrane sealing the cartridge closed and fluidly connect the cartridge to the tire. When pierced, the cartridge delivers gas into the tire via the inflator head. The inflator head may have a valve to control the amount and rate at which gas enters the tire.

FIGS. 1 and 2 show a conventional CO₂ inflator head 10 for rapidly inflating a tire of a bicycle. Head 10 is configured to simultaneously engage a compressed CO₂ cartridge (not shown) and a valve (not shown) of the tire. To engage the valve, head 10 includes a nozzle 20 having a conventional valve engaging portion (not shown). To engage the CO₂ cartridge, the CO₂ cartridge is inserted into head 10. Head 10 includes a piercing member 40 having a pointed end 41 for puncturing a membrane (not shown) of the CO₂ cartridge and an annular shoulder 42 adjacent pointed end 41. Head 10 also includes resilient member 50. As the CO₂ cartridge is inserted into head 10, resilient member 50 is deformed. The CO₂ cartridge membrane is fully punctured when shoulder 42 of piercing member 40 abuts against the CO₂ cartridge. With shoulder 42 abutting the CO₂ cartridge, an airtight seal is provided between the CO₂ cartridge and head 10 and the gas pressure in the CO₂ cartridge is maintained without the risk of gas outflow. To allow gas to flow from the CO₂ cartridge to the tire via head 10, the CO₂ cartridge is partially withdrawn from piercing member 40. With shoulder 42 displaced away from the CO₂ cartridge, gas can exit the CO₂ cartridge, flow through a channel 43 defined by piercing member 40 and through a gas passageway 12 of head 10, and exit head 10 via nozzle 20 as indicated by arrows 70. Channel 43, best shown in FIG. 1, is typically narrow to keep head 10 compact. Since the gas pressure of a typical compressed gas cartridge is high, a larger channel is not conventionally required. Another advantage conferred by the narrow and low volume channel 43 includes the control a user is provided over the rate at which gas enters a tire to avoid over inflation. This is particularly important where the user is inflating a low volume tire, such as a road bicycle tire.

FIGS. 3 and 4 show a conventional CO₂ inflator head 100. Many features and components of inflator head 100 are similar to features and components of inflator head 10, with the same reference numerals being used preceded by “1” to indicate features of inflator head 100 that are similar to those of inflator head 10. Inflator head 100 differs from inflator head 10 in that channel 43 of head 10 is replaced with a gas flow channel 144 extending through a piercing member 140 of inflator head 100 for delivering gas from a CO₂ cartridge (not shown) to a valve (not shown) of a tire to be inflated. Like channel 43 of inflator head 10, gas flow channel 144 of head 100 is narrow to keep head 100 compact. Since resilient member 150 is not able to seal gas flow channel 144, additional components are required to seal gas flow channel 144 to prevent gas from escaping the CO₂ cartridge when the CO₂ cartridge is connected to inflator head 100 and gas from the CO₂ cartridge is not desired (e.g. when the tire valve is not connected to inflator head 100).

Compressed gas cartridges used in conjunction with an inflator head (such as inflator head 10 or 100) give cyclists the ability to inflate a flat tire quickly and with little effort. However, leaks can occur during tire inflation and/or the cartridge may lack sufficient gas to fill the tire. Since compressed gas cartridges are typically costly, many cyclists opt to carry a bicycle pump in combination with compressed gas cartridges and an inflator head.

One-piece pumps that allow users to inflate a tire manually or by using a compressed gas cartridge are known. FIG. 5 shows a conventional one-piece pump 200. Pump 200 includes a pump inflator head 210 and a separate compressed gas inflator head 220, wherein both inflator heads are attached to a gas dispensing end 201 of the pump. Many of the features and components of compressed gas inflator head 220 may be similar to features and components of inflator head 10 or 100 described elsewhere herein. To inflate a tire (not shown) using compressed gas, a compressed gas cartridge 240 is connected to compressed gas inflator head 220. Compressed gas cartridge 240 includes a membrane 241, which is punctured as described elsewhere herein with reference to the FIG. 1 inflator head. Gas then flows through compressed gas inflator head 220 to inflate the tire. While compressed gas inflator head 220 can be used to rapidly inflate a tire with high-pressure gas from a compressed gas cartridge, the narrow gas flow channel that is typical of compressed gas inflator head 220 (described elsewhere herein) make it undesirable for use with a conventional hand-actuated pump. This is because hand-actuated pumps typically pump a higher volume of air per stroke than can flow through the narrow gas flow channel of compressed gas inflator head 220 when a user actuates the piston at an average speed. This effect is exacerbated with the use of extra high volume pumps typically used to inflate a larger volume mountain bicycle tire. Thus, due to the added resistance imparted by the typically narrow gas flow channel of compressed gas inflator head 220, a user would need to expend considerable time and energy to inflate a tire using a hand-actuated pump having compressed gas inflator head 220. Accordingly, pump 200 includes separate pump inflator head 210. To manually pump air into a tire (not shown), the user hand-activates a piston 202 to draw air into pump 200 and then displace that air into the tire. Air flows through pump inflator head 210 to inflate the tire. However, having two inflator heads (i.e. pump inflator head 210 and compressed gas inflator head 220) increases the size, weight, and number of parts of the one-piece pump. Further, compressed gas inflator head 220 is not removable. Thus, a user must purchase a separate compressed gas inflator head if the user desires to travel without a hand-actuated pump for the reasons described elsewhere herein.

Alternative one piece pumps (not shown) that allow users to inflate a tire manually or by using a compressed gas cartridge are known. Such pumps require gas from the compressed gas cartridge to flow through the pump air chamber. In other words, the compressed gas cartridge is connected to the pump air chamber. Thus, the inflator head of such pumps lacks the piercing member required to puncture the membrane of the cartridge and such pumps require additional components to puncture the cartridge membrane which adds to the size and weight of the pump. The pump body of such pumps must also be capable of withstanding the higher gas pressure from a compressed gas cartridge as compared to the pressures associated with hand-actuation/manual pumping. This adds to the weight and cost of such pumps. Also, the inflator head of such pumps is not removable. Even if the inflator head of such pumps was removable, the inflator head lacks the piercing member required to puncture the membrane of a compressed gas cartridge.

There is a general desire for a relatively light and compact one-piece pump that allows a user to inflate a tire with a hand-actuated pump and with a compressed gas cartridge.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides an inflator head. The inflator head is operable with a pump for manually inflating a tire and is removable from the pump for inflating the tire using the compressed gas cartridge. The inflator head includes a body having a first aperture for engaging a compressed gas cartridge at a first end and a second aperture for engaging a tire valve at a second end opposed to the first end. A piercing member is disposed at the first aperture and housed in a piercing member channel fluidly connected to the first aperture. One or more gas flow channels are defined by the body and fluidly connect the first aperture to a gas flow passageway. The gas flow passageway fluidly connects the one or more gas flow channels and the second aperture.

In some embodiments, the piercing member channel defines the one or more gas flow channels.

In some embodiments, the one or more gas flow channels are evenly distributed about the piercing member channel.

In some embodiments, the one or more body flow channels are positioned adjacent to and separate from the piercing member channel.

In some embodiments, the one or more gas flow channels are positioned adjacent to and separate from the piercing member channel.

In some embodiments, a gas flow through the inflator head follows an equivalent path when the inflator head is used with the pump and when the inflator head is used with the compressed gas cartridge.

In some embodiments, the pump comprises a portable hand-actuated bicycle pump or a floor bicycle pump.

Another aspect of the invention provides a bicycle pump comprising a removable inflator head. The inflator head is operable with the pump for manually inflating a tire and is removable from the pump for inflating the tire using a compressed gas cartridge. The inflator head includes a body having a first aperture for engaging the compressed gas cartridge at a first end and a second aperture for engaging a tire valve at a second end opposed to the first end. A piercing member is disposed at the first aperture and housed in a piercing member channel fluidly connected to the first aperture. One or more gas flow channels are defined by the body and fluidly connect the first aperture to a gas flow passageway. The gas flow passageway fluidly connects the one or more gas flow channels and the second aperture.

In some embodiments, the piercing member channel defines the one or more of gas flow channels.

In some embodiments, the one or more gas flow channels are evenly distributed about the piercing member channel.

In some embodiments, the one or more body flow channels are positioned adjacent to and separate from the piercing member channel.

In some embodiments, the one or more gas flow channels are positioned adjacent to and separate from the piercing member channel.

In some embodiments, a gas flow through the inflator head follows an equivalent path when the inflator head is used with the pump and when the inflator head is used with the compressed gas cartridge.

In some embodiments, the pump comprises a portable hand-actuated bicycle pump or a floor bicycle pump.

Another aspect of the invention provides an inflator head for a pump. The inflator head is operable with a pump for manually inflating a tire and is removable from the pump for inflating the tire using the compressed gas cartridge. The inflator head includes a valve engaging part and a compressed gas cartridge engaging part fluidly connected to the valve engaging part. The compressed gas cartridge engaging part includes a body, a piercing member housed in a piercing member channel, and one or more gas flow channels defined by the body proximate the piercing member channel.

In some embodiments, the piercing member channel defines the one or more gas flow channels.

In some embodiments, the one or more gas flow channels are evenly distributed about the piercing member channel.

In some embodiments, the compressed gas cartridge engaging part includes a body flow channel extending therethrough adjacent to and separate from the piercing member channel.

In some embodiments, the one or more gas flow channels extend through the compressed gas cartridge engaging part adjacent to and separate from the piercing member channel.

In some embodiments, the valve engaging part and the compressed gas cartridge engaging part are integrally formed.

In some embodiments, the valve engaging part and the compressed gas cartridge engaging part are fluidly connected by a flexible tube.

In some embodiments, a gas flow through the inflator head follows an equivalent path when the inflator head is used with the pump and when the inflator head is used with the compressed gas cartridge.

In some embodiments, the pump comprises a portable hand-actuated bicycle pump or a floor bicycle pump.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a side elevation cross sectional view of a conventional carbon dioxide (CO₂) inflator head.

FIG. 2 is a rear elevation view of the CO₂ inflator head shown in FIG. 1.

FIG. 3 is a side elevation cross sectional view of a conventional CO₂ inflator head.

FIG. 4 is a rear elevation view of the CO₂ inflator head shown in FIG. 3.

FIG. 5 is a side elevation cross sectional view of a conventional bicycle pump in a partial up-stroke position.

FIG. 6A is a perspective view of a bicycle pump according to an example embodiment of the present invention.

FIG. 6B is a perspective view of the bicycle pump shown in FIG. 6A in an up-stroke position.

FIG. 7 is a side elevation cross sectional view of the bicycle pump shown in FIG. 6A.

FIG. 8A is a side elevation cross sectional view of the bicycle pump shown in FIG. 6B.

FIG. 8B is an expanded side elevation cross sectional view of the bicycle pump head shown in FIG. 6B.

FIG. 9 is a side elevation cross section view of the bicycle pump shown in FIG. 6A, wherein a tire inflator head is removed therefrom.

FIG. 10 is a top, front, left side perspective view of a tire inflator head according to an example embodiment of the present invention.

FIG. 11 is a top, rear, right side perspective view of the tire inflator head shown in FIG. 10.

FIG. 12 is a side elevation view of the tire inflator head shown in FIG. 10.

FIG. 13 is a top elevation view of the tire inflator head shown in FIG. 10.

FIG. 14 is a rear elevation view of the tire inflator head shown in FIG. 10.

FIG. 15 is a rear elevation view of the tire inflator head shown in FIG. 10, wherein an O-ring has been omitted so that gas flow channels are visible.

FIG. 16 is a front elevation view of the tire inflator head shown in FIG. 10

FIG. 17 is a side elevation cross sectional view of the tire inflator head shown in FIG. 10.

FIG. 18 is a side elevation cross sectional view of the tire inflator head shown in FIG. 10 connected to a compressed gas cartridge, wherein the cartridge is fully inserted into the tire inflator head.

FIG. 19 is a side elevation cross sectional view of the tire inflator head shown in FIG. 10 connected to a compressed gas cartridge, wherein the cartridge is partially withdrawn from the tire inflator head.

FIG. 20 is a side elevation cross sectional view of a tire inflator head according to an example embodiment of the present invention.

FIG. 21 is a rear elevation view of the tire inflator head shown in FIG. 20, wherein an O-ring has been omitted so that a gas flow channel is visible.

FIG. 22 is a side elevation view of a tire inflator head according to an example embodiment of the present invention.

FIG. 23 is a side elevation cross sectional view of the tire inflator head shown in FIG. 22.

FIG. 24 is a rear elevation view of the tire inflator head shown in FIG. 22, wherein an O-ring has been omitted so that gas flow channels are visible.

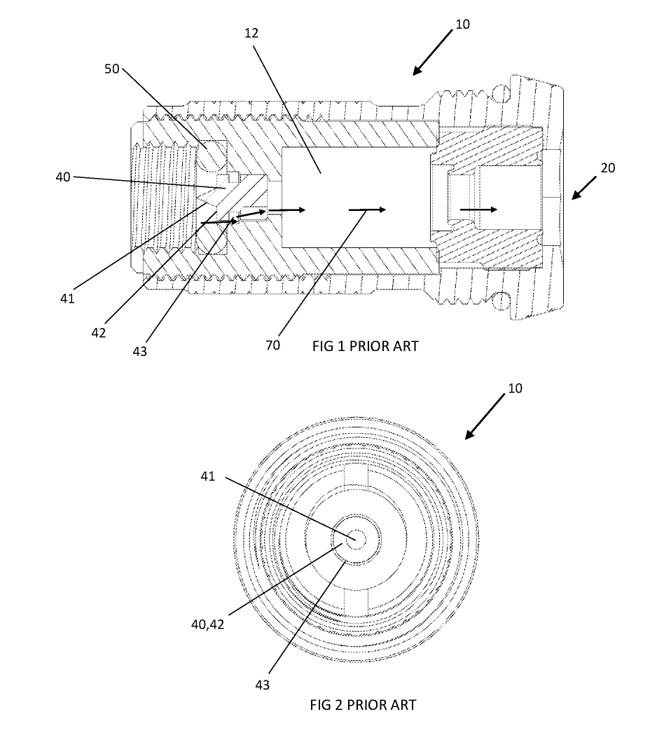

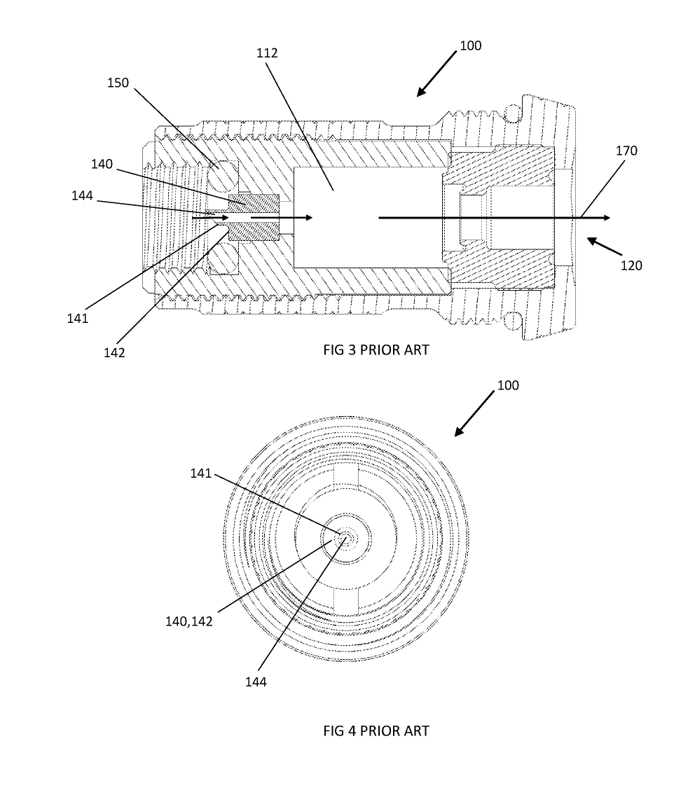

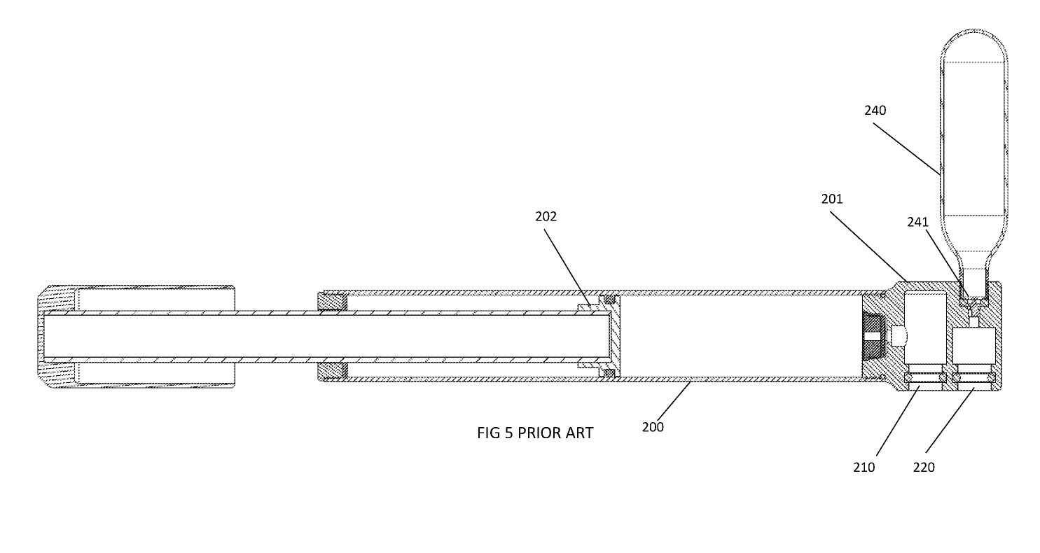

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

Some embodiments of the present invention provide a bicycle pump that allows a user to inflate a tire using a hand-actuated pump and/or a compressed gas cartridge. The pump includes an inflator head that serves as a pump inflator head to allow a user to inflate a tire using the hand-actuated pump. The inflator head can be removed from the pump to be used as a compressed gas inflator head in conjunction with a compressed gas cartridge to inflate a tire with pressurized gas. Since the inflator head serves as the pump inflator head when connected to the pump and a compressed gas inflator head when removed from the pump, a user is not required to carry both a hand-actuated pump and a separate compressed gas inflator head. The inflator head includes one or more gas flow channels proximate a piercing member for high-volume gas flow through the inflator head. The inflator head may include a flexible hose for facilitating gas delivery from a compressed gas cartridge to a tire to be inflated.

Some embodiments of the present invention provide a method for inflating a tire. The method includes removing an inflator head from a pump head of a hand-actuated pump and connecting a compressed gas cartridge to the inflator head. A valve of the tire to be inflated is fluidly connected to the inflator head. The compressed gas cartridge is partially withdrawn from the inflator head to allow gas from the cartridge to flow through the inflator head into the tire. When the cartridge is empty, the valve and cartridge are removed from the inflator head and the inflator head is then reattached to the pump. If the tire is sufficiently inflated before the cartridge is empty, the cartridge can be fully connected to the inflator head to stop gas from flowing from the cartridge and through the inflator head. The valve can then be removed from the inflator head. The cartridge, connected to the inflator head, can be stored for use at a later time. Alternatively, the cartridge can be removed from the inflator head and the inflator head reattached to the pump.

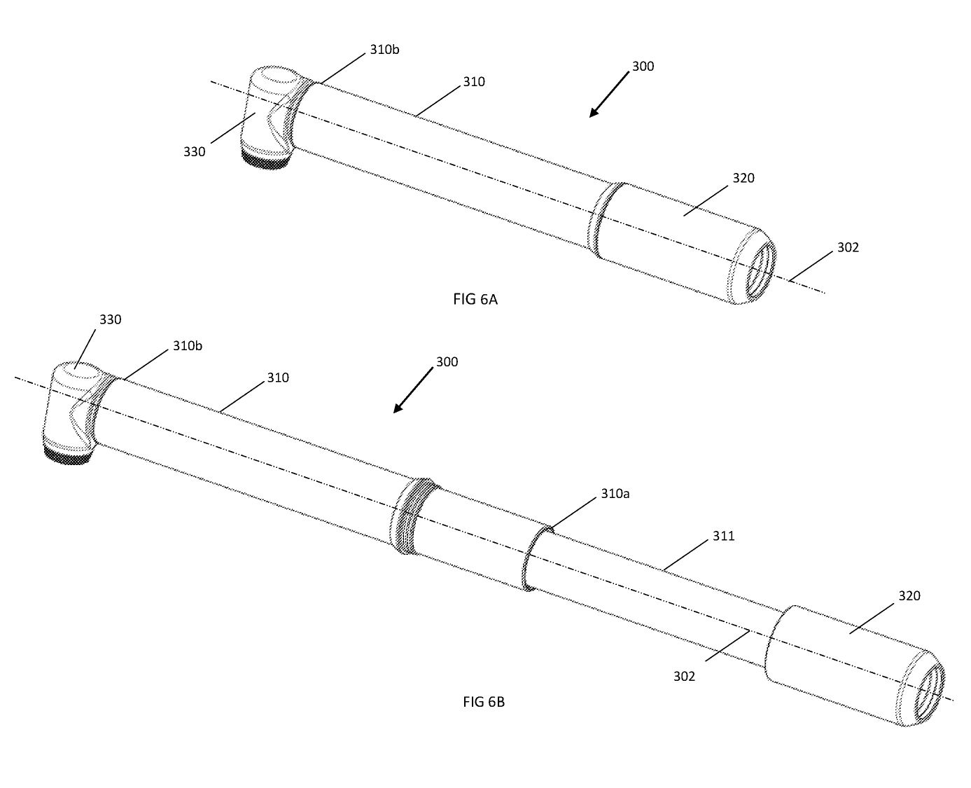

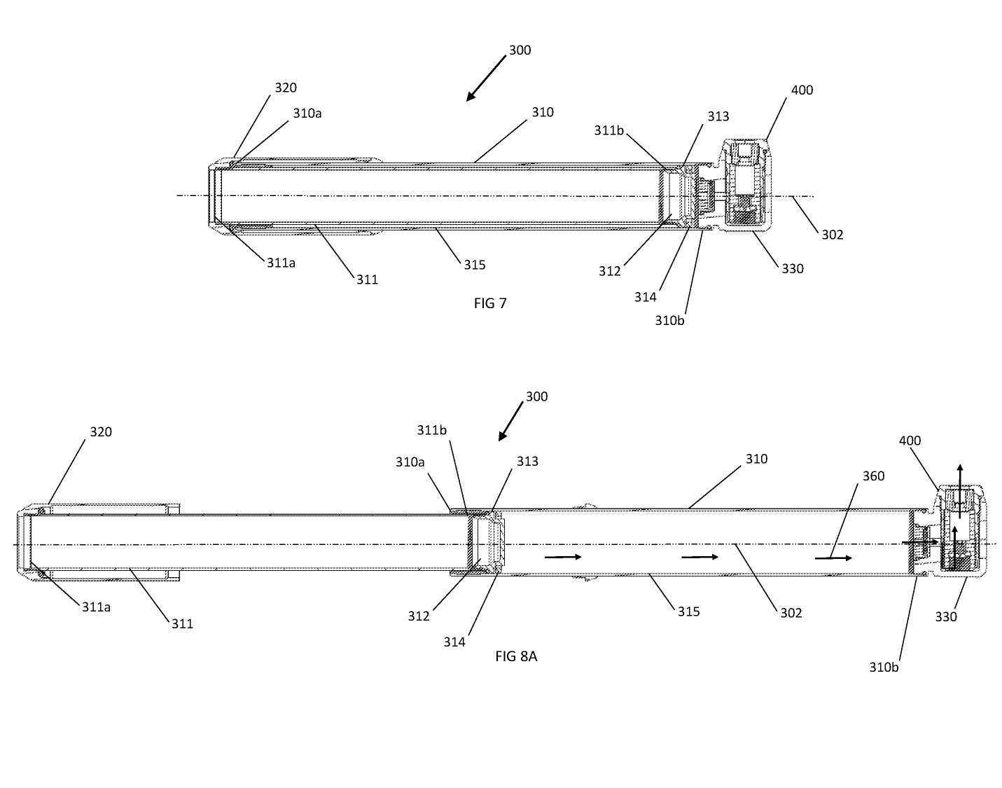

FIGS. 6-9 show various views of a bicycle pump 300 according to a particular embodiment. Pump 300 comprises a pump body 310, a handle 320, and a pump head 330. Handle 320 and pump head 330 are disposed at opposite ends 310a, 310b of pump body 310. Pump body 310 houses a plunger 311 and a piston 312. Plunger 311 is connected at a first end 311a to handle 320 for pump actuation and at a second end 311b opposed to first end 311a to piston 312. In some embodiments, piston 312 includes an O-ring 314. A radial outward edge 313 of piston 312 and/or O-ring 314 engage an inside surface 315 of pump body 310. Pump 300 is hand-actuated as is conventionally known by pumping handle 320 to actuate piston 312 inside pump body 310 to draw air into and displace air from pump body 310. During an up-stroke, piston 312 draws external air into pump body 310. During a down-stroke, piston 312 displaces the air in pump body 310 into a bicycle tire (not shown) via pump head 330.

Unless the context dictates otherwise, the terms “radially outward”, “radially outwardly”, and/or the like (as used herein) refer to directions that extend generally orthogonal to and away from a central axis 302 or 402 or, where the context dictates, have components that extend generally orthogonal to and away from central axis 302 or 402. Unless the context dictates otherwise, the terms “radially inward”, “radially inwardly”, and/or the like (as used herein) refer to directions that extend generally orthogonal and toward central axis 302 or 402 or, where the context dictates, have components that extend generally orthogonal to and toward central axis 302 or 402. Unless the context dictates otherwise, the terms “radial”, “radially”, and/or the like (as used herein) refer to directions that are either radially inward, radially outward, or both. Although the term “radial” is most commonly used in connection with circular objects or features, it should be understood for the purpose of this description and accompanying aspects that the term “radial” is used in a broader context and is not limited to describing strictly circular objects or features or objects or features with strictly circular cross-section.

In the FIGS. 6-9 embodiment, pump 300, pump body 310, handle 320, plunger 311, and piston 312 are substantially tubular and have an annular shape about central axis 302. Although the term “annular” is most commonly used in connection with objects and/or features having circular profiles, it should be understood for the purpose of this description and accompanying claims that the term “annular” is used in a broader context and is not limited to describing strictly circular objects or features or objects or features with strictly circular profiles or cross-sections. Handle 320 has a diameter that is greater than the diameter of pump body 310 so that pump body 310 and handle 320 slide telescopically when pump 300 is actuated. In this way, pump 300 has a compact configuration. Plunger 311 has a diameter that is less than the diameter of both pump body 310 and handle 320. In some embodiments, plunger 311 comprises a rod extending between handle 320 and piston 312.

Pump head 330 is connected to pump body 310 at end 310b. In the FIG. 6-9 embodiment, pump head 330 includes threads (not shown) to threadedly attach pump head 330 to pump body 310, although this is not necessary. Persons skilled in the art will recognize that pump head 330 may be attached to pump body 310 using any means conventionally known. For example, pump head 330 may be snap-fit to pump body 310. An O-ring (not shown) may be provided to fluidly seal pump head 330 to pump body 310 such that air from pump body 310 is forced through pump head 330 when pump 300 is actuated. In some embodiments, pump head 330 and pump body 310 are integrally formed. Pump head 330 defines a cavity 334 (FIG. 9) that extends in a substantially perpendicular direction to central axis 302. In the FIGS. 6-9 embodiment, cavity 334 includes threads 335 to threadedly engage threads 401 of inflator head 400. Persons skilled in the art will recognize that inflator head 400 may be removeably attached to pump head 330 using any means conventionally known. For example, inflator head 400 may be snap-fit to pump head 330. An O-ring (not shown) may be provided to fluidly seal inflator head 400 to pump head 330 such that air from pump body 310 is forced through inflator head 400 when pump 300 is actuated.

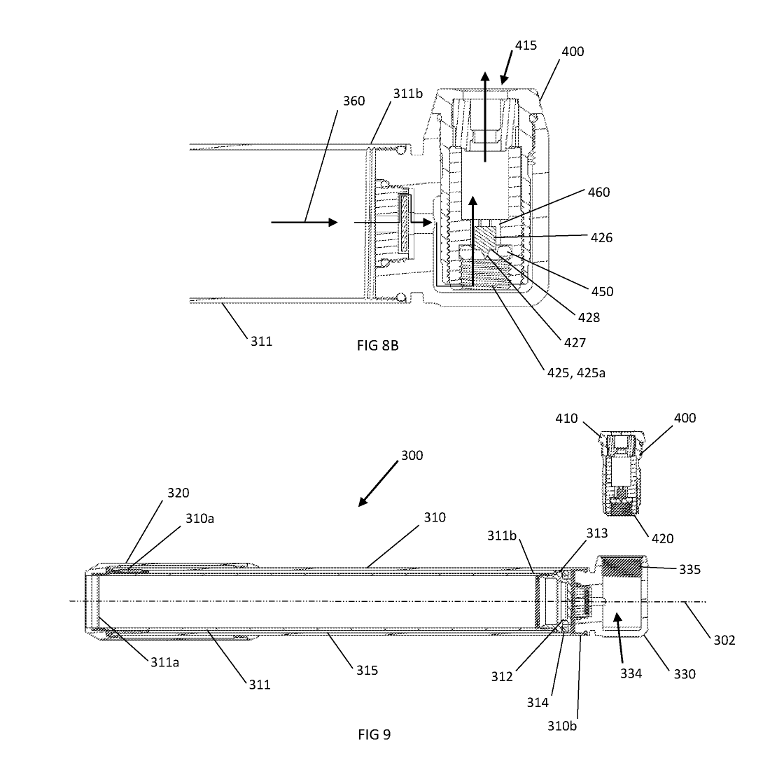

When inflator head 400 is connected to pump head 330, pump 300 may be used to manually inflate a tire. Inflator head includes a valve engaging part 410 for engaging a valve (not shown) of the tire as is conventionally known. During a down-stroke, piston 312 displaces air from pump body 310 into the tire via inflator head 400 as shown by arrows 360 (FIG. 8).

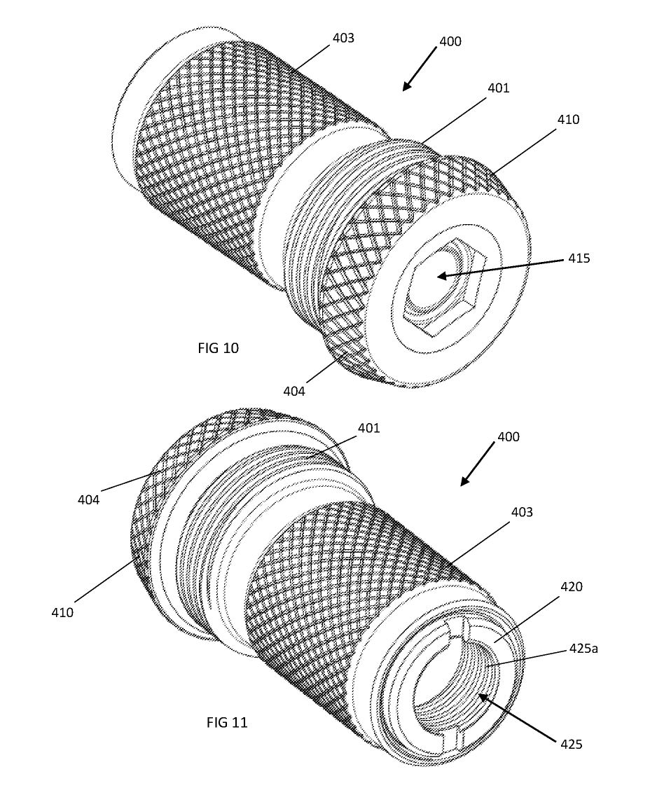

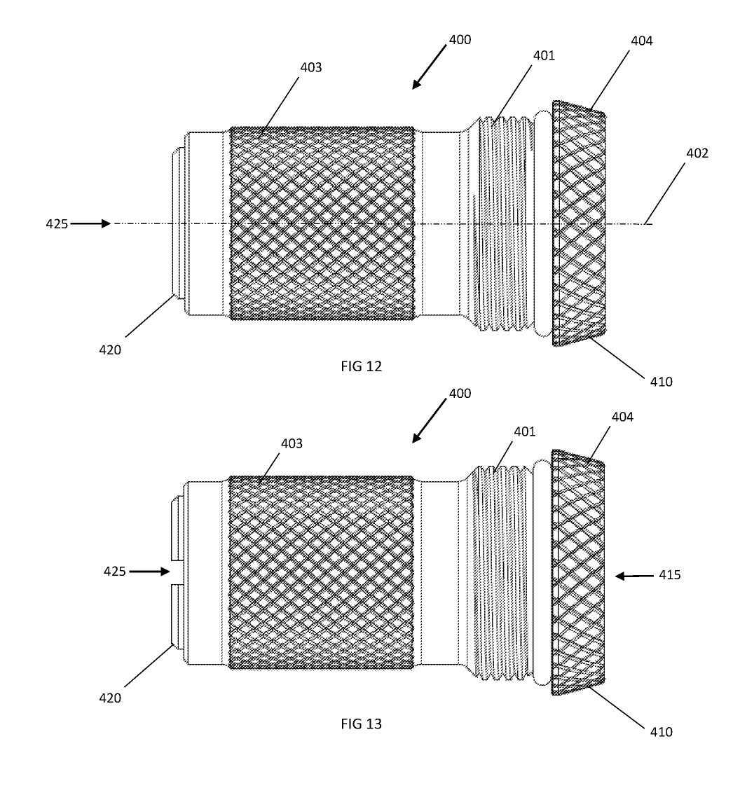

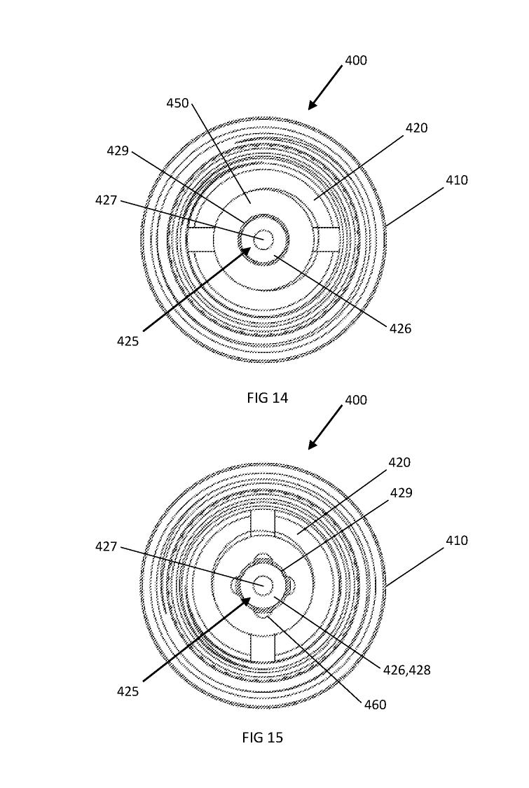

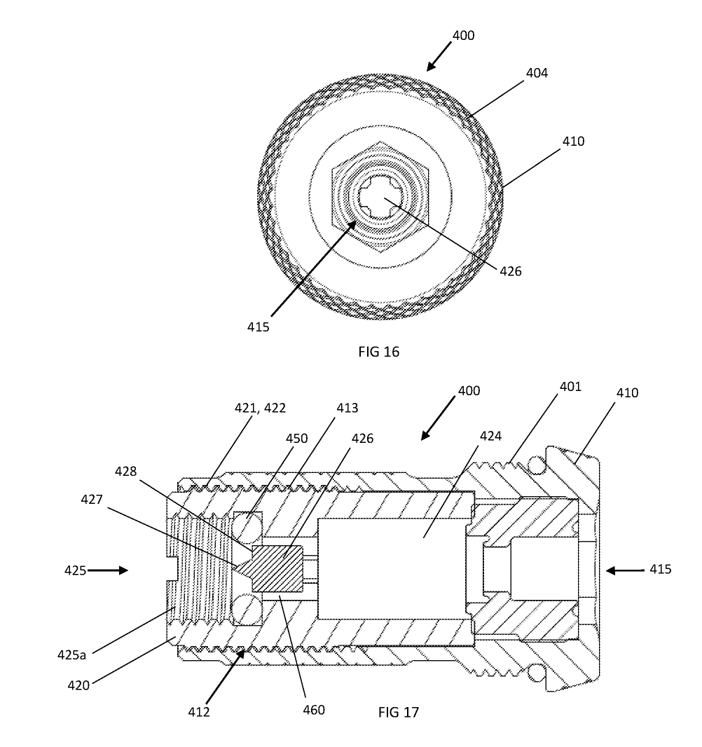

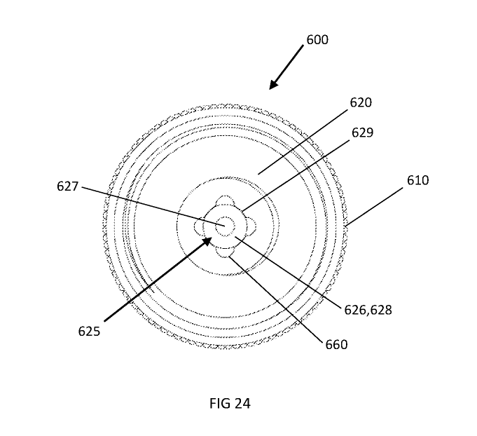

When inflator head 400 is removed from pump head 330, inflator head 400 may be used to inflate a tire using a compressed gas cartridge 370. FIGS. 10-19 show various views of inflator head 400 according to a particular embodiment. To assist handling of inflator head 400, radial outward surfaces 403, 404 of inflator head 400 may be embossed as is conventionally known. Inflator head 400 includes valve engaging part 410 and a compressed gas cartridge engaging part 420. In the FIGS. 10-19 embodiment, inflator head 400, valve engaging part 410 and compressed gas cartridge engaging part 420 are substantially tubular and have an annular shape about central axis 402 (FIG. 12). In the FIGS. 10-19 embodiment, valve engaging part 410 defines a cavity 412 (FIG. 17) having threads 413 for threadedly engaging threads 422 on a radial outward surface 421 of compressed gas cartridge engaging part 420, although this is not necessary. Persons skilled in the art will recognize that compressed gas cartridge engaging part 420 may be attached to valve engaging part 410 using any means conventionally known. For example, valve engaging part 410 may be snap-fit to compressed gas cartridge engaging part 420. Persons skilled in the art will further recognize that compressed gas cartridge engaging part 420 may define a cavity and parts 410 and 420 may be connected by inserting valve engaging part 410 into the cavity of compressed gas cartridge engaging part 420. In some embodiments, valve engaging part 410 and compressed gas cartridge engaging part 420 are integrally formed. In some embodiments, valve engaging part 410 and compressed gas cartridge engaging part 420 are fluidly connected by a flexible tube (FIGS. 23-26).

Valve engaging part 410 includes a nozzle 415 for engaging the valve (not shown) of a tire to be inflated as is conventionally known. Nozzle 415 is fluidly connected to compressed gas cartridge engaging part 420 via gas passageway 424 of part 420.

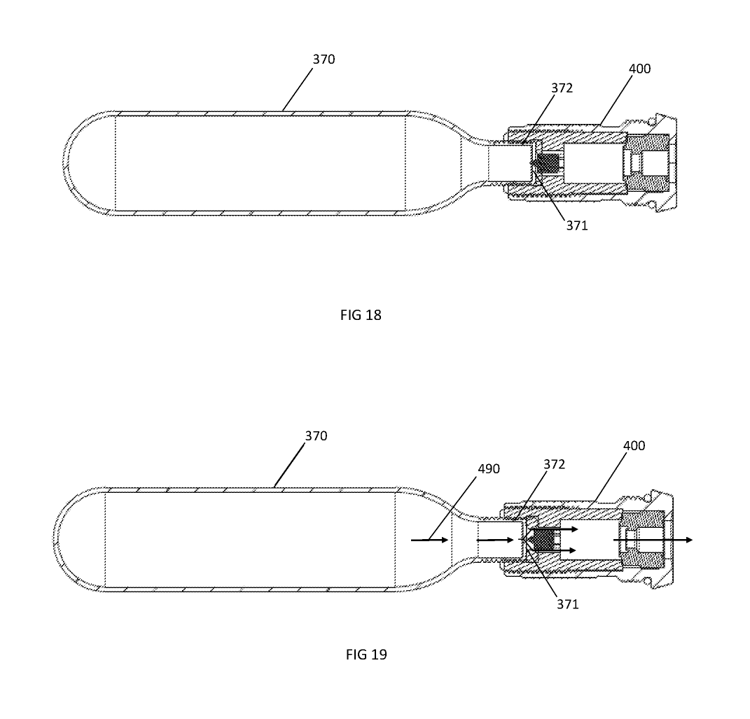

To inflate a tire fluidly connected to nozzle 415, compressed gas cartridge 370 is connected to compressed gas cartridge engaging part 420 via an aperture 425 of part 420 (FIGS. 18-19). In the FIGS. 10-19 embodiment, aperture 425 includes threads 425a for threadedly engaging a threaded end (not shown) of cartridge 370, although this is not necessary. Persons skilled in the art will understand that some compressed gas cartridges may be unthreaded and must be held in fluid connection with a compressed gas inflator head to inflate a tire. Compressed gas cartridge engaging part 420 includes an annular piercing member 426 (FIG. 17) having a pointed end 427 for puncturing a membrane 371 of cartridge 370 and an annular shoulder 428 adjacent pointed end 427. Piercing member 426 is housed in an annular piercing member channel 429. Piercing member 426 may be pressed into or threadedly connected inside piercing member channel 429 as is conventionally known. To fluidly connect aperture 425 to gas passageway 424, piercing member channel 429 defines one or more gas flow channels 460. Gas flow channel(s) 460 extend(s) from aperture 425 to gas passageway 424. In the FIGS. 10-19 embodiment, compressed gas cartridge engaging part 420 includes four substantially identical gas flow channels 460 radially distributed about channel 429. The size, distribution, and shape of gas flow channels 460 need not be the same. Gas flow channels 460 may comprise any geometric shape.

When cartridge 370 is fully inserted into aperture 425 of inflator head 400, pointed end 427 punctures membrane 371. Membrane 371 is fully punctured when shoulder 428 of piercing member 426 abuts against threaded end 372 of cartridge 370. With shoulder 428 abutting cartridge 370, an airtight seal is provided between cartridge 370 and inflator head 400 and the gas pressure in cartridge 370 is maintained without the risk of gas outflow. Compressed gas cartridge engaging part 420 may include an O-ring 450 to fluidly seal cartridge 370 to inflator head 400 such that gas from cartridge 370 is forced through inflator head 400 and does not leak. The valve of a tire to be inflated is fluidly connected to nozzle 415 of valve engaging part 410 as is conventionally known. To allow gas to flow from cartridge 370 to the tire to be inflated via inflator head 400, cartridge 370 is partially withdrawn from compressed gas cartridge engaging part 420. With shoulder 428 displaced away from cartridge 370, gas can exit cartridge 370, flow through one or more gas flow channels 460 of part 420 to passageway 424, and exit inflator head 400 via nozzle 415 as indicated by arrows 490.

Gas flow channels 460 improve gas flow through inflator head 400 so that the inflator head may be used with a compressed gas cartridge or a manually-actuated pump. When inflator head 400 is used with a manually-actuated pump (such as pump 300), inflator head 400 does not add resistance during manual pumping beyond that typically experienced using a conventional inflator head of a hand-actuated pump. In other words, air flows through inflator head 400 substantially unrestricted. Further, since the channel volume of inflator head 400 is greater than that of a conventional compressed gas inflator head, a compressed gas cartridge is less likely to become clogged by frost and/or ice caused when high pressure gas is released from the cartridge when used with inflator head 400. A user can easily mistake a clogged cartridge with an empty compressed gas cartridge. If the clogged cartridge is removed from an inflator head before the cartridge is emptied, it can become a safety concern to the user. When the ice/frost clogging the removed cartridge thaws, the residual high pressure gas remaining inside the cartridge is suddenly released, causing the cartridge to propel like a rocket. Such safety concerns are minimized using inflator head 400 with a compressed gas cartridge. Also, since inflator head 400 doubles as both a compressed gas inflator head and a manually-actuated pump inflator head, users save the weight and/or space that would be required to carry both a manually-actuated pump head and a separate compressed gas inflator head. Further still, when inflator head 400 is connected to pump 300, piercing member 426 is located inside the pump. Thus, piercing member 426 is not exposed to external elements (such as dirt and debris) when installed in pump 300. Piercing member 426 is only exposed to external elements that could impede its function when inflator head 400 is disconnected from pump 300.

Since inflator head 400 does not add resistance during manual pumping, inflator head 400 is compatible for use with a manually-actuated bicycle pump, including pumps for mountain bicycle tires which typically have a larger volume than conventional road bicycle tires. Inflator head 400 can also be used with a hand-actuated pump to “seat” a tubeless tire, including (but not limited to) a tubeless mountain bicycle tire. Inflation speed is important when seating a tubeless tire to a wheel rim since air escapes from around the entire diameter of the tire as air is initially pumped through the tire valve. To successfully seat the tire, more air must be pumped through the valve than escapes from the tire. Conventional compressed gas inflator heads would add resistance to manual pumping and impede the amount of air pumped through the valve, thereby compromising the ability of a user to seat a tubeless tire.

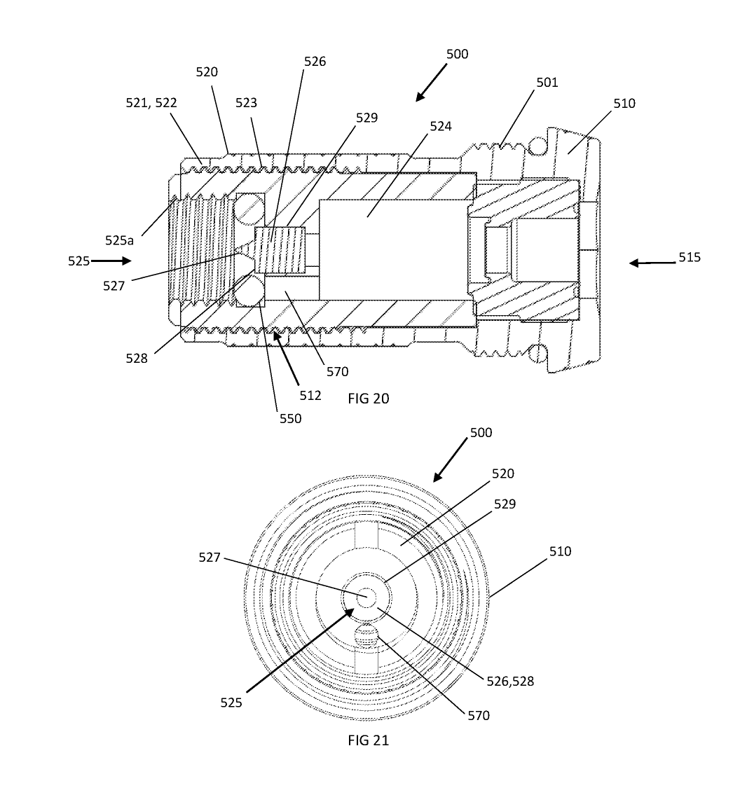

FIGS. 20-21 show various views of inflator head 500 according to a particular embodiment. Many features and components of inflator head 500 are similar to features and components of inflator head 400, with the same reference numerals being used in the “500” series instead of the “400” series to indicate features of inflator head 500 that are similar to those of inflator head 400. A significant difference between inflator head 500 and inflator head 400 is in how gas flows through inflator head 500. In the FIGS. 20-21 embodiment, compressed gas cartridge engaging part 520 of inflator head 500 defines one or more gas flow channels 570. Gas flow channel(s) 570 extend(s) through part 520 from aperture 525 to passageway 524 adjacent to and separate from a piercing member channel 529. Gas flow channel(s) 570 may comprise any geometric shape. In the FIGS. 20-21 embodiment, compressed gas cartridge engaging part 520 defines one annular gas flow channel 570 extending from aperture 525 to passageway 524.

Gas flow channel(s) 570 improve(s) gas flow through inflator head 500 so that the inflator head may be used with a compressed gas cartridge or a manually-actuated pump. Like inflator head 400, gas flow channel(s) 570 improve(s) the volume of gas that can flow through inflator head 500. When inflator head 500 is used with a manually-actuated pump (such as pump 300), inflator head 500 does not substantially add resistance during manual pumping beyond that experienced using a conventional inflator head of a hand-actuated pump (as described elsewhere herein).

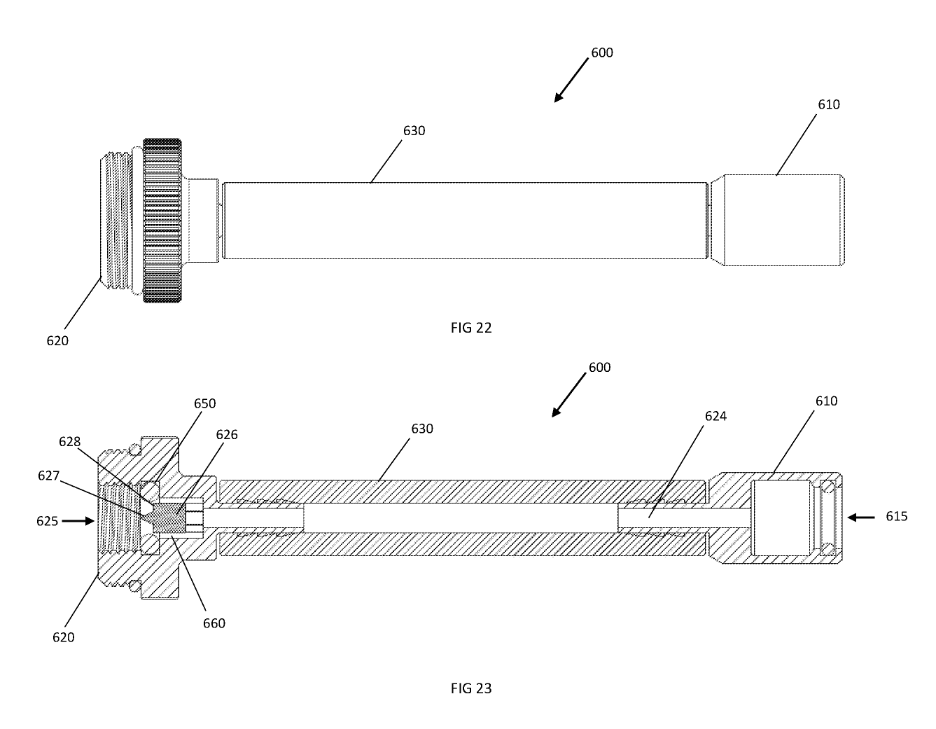

FIGS. 22-24 show various views of an inflator head 600 according to a particular embodiment. Many features and components of inflator head 600 are similar to features and components of inflator head 400, with the same reference numerals being used in the “600” series instead of the “400” series to indicate features of inflator head 600 that are similar to those of inflator head 400. A significant difference between inflator head 600 and inflator head 400 is that, to facilitate delivery of gas from a compressed gas cartridge to a tire, inflator head 600 includes a flexible tube 630 fluidly connecting valve engaging part 610 and compressed gas cartridge engaging part 620. In some embodiments (not shown), to improve gas flow, inflator head 600 may additionally or alternatively include one or more gas flow channels extending through the compressed gas cartridge engaging part from the aperture to the passageway adjacent to and separate from the piercing member channel (such as channel(s) 570).

In some embodiments (not shown), to improve gas flow, the inflator head may include both one or more channels defined by the piercing member channel (such as channel(s) 460) and one or more gas flow channels extending through the compressed gas cartridge engaging part from the aperture to the passageway adjacent to and separate from the piercing member channel (such as channel(s) 570). In some embodiments, the inflator head may additionally include one or more gas flow channels defined by the piercing member.

While a number of exemplary aspects and embodiments have been discussed above, those of skill in the art will recognize certain modifications, permutations, additions and sub-combinations thereof.

For example, persons skilled in the art will recognize that:
the inflator head described herein may be used with various types of hand-actuated pumps including, but not limited to, hand-actuated pumps for bicycles and floor pumps for bicycles;
the inflator head described herein may include a valve to control the amount and rate at which gas from a compressed gas cartridge enters a tire to be inflated;
a compressed gas cartridge may be stored inside pump 300.

It is therefore intended that the following appended claims and claims hereafter introduced are interpreted to include all such modifications, permutations, additions and sub-combinations as are consistent with the broadest interpretation of the specification as a whole.

1. An inflator head for a pump, the inflator head comprising:
a body having a first aperture for engaging a compressed gas cartridge at a first end and a second aperture for engaging a tire valve at a second end opposed to the first end;
a piercing member disposed at the first aperture and housed in a piercing member channel fluidly connected to the first aperture;
one or more gas flow channels defined by the body and fluidly connecting the first aperture to a gas flow passageway; and
the gas flow passageway fluidly connecting the one or more gas flow channels and the second aperture,
wherein the inflator head is removeably engageable with the pump for manually inflating a tire.

2. An inflator head according to claim 1, wherein the piercing member channel defines the one or more gas flow channels.

3. An inflator head according to claim 2, wherein the one or more gas flow channels are evenly distributed about the piercing member channel.

4. An inflator head according to claim 3, wherein the one or more body flow channels are positioned adjacent to and separate from the piercing member channel.

5. An inflator head according to claim 1, wherein the one or more gas flow channels are positioned adjacent to and separate from the piercing member channel.

6. An inflator head according to claim 1, wherein a gas flow through the inflator head follows an equivalent path when the inflator head is used with the pump and when the inflator head is used with the compressed gas cartridge.

7. A bicycle pump comprising a removable inflator head, wherein the inflator head comprises:
a body having a first aperture for engaging a compressed gas cartridge at a first end and a second aperture for engaging a tire valve at a second end opposed to the first end;
a piercing member disposed at the first aperture and housed in a piercing member channel fluidly connected to the first aperture;
one or more gas flow channels defined by the body and fluidly connecting the first aperture to a gas flow passageway; and
the gas flow passageway fluidly connecting the one or more gas flow channels and the second aperture,
wherein the inflator head is operable with the pump for manually inflating a tire and is removable from the pump for inflating the tire using the compressed gas cartridge.

8. A bicycle pump according to claim 7, wherein the piercing member channel defines the one or more gas flow channels.

9. A bicycle pump according to claim 8, wherein the one or more gas flow channels are evenly distributed about the piercing member channel.

10. A bicycle pump according to claim 8, wherein the one or more body flow channels are positioned adjacent to and separate from the piercing member channel.

11. A bicycle pump according to claim 7, wherein the one or more gas flow channels are positioned adjacent to and separate from the piercing member channel.

12. A bicycle pump according to claim 7, wherein a gas flow through the inflator head follows an equivalent path when the inflator head is used with the pump and when the inflator head is used with the compressed gas cartridge.

13. An inflator head for a pump, the inflator head comprising:
a valve engaging part;
a compressed gas cartridge engaging part fluidly connected to the valve engaging part, the compressed gas cartridge engaging part comprising a body, a piercing member housed in a piercing member channel, and one or more gas flow channels defined by the body proximate the piercing member channel, wherein the inflator head is operable with a pump for manually inflating a tire and is removable from the pump for inflating the tire using the compressed gas cartridge.

14. An inflator head according to claim 13, wherein the piercing member channel defines the one or more gas flow channels.

15. An inflator head according to claim 14, wherein the one or more gas flow channels are evenly distributed about the piercing member channel.

16. An inflator head according to claim 14, further comprising a body flow channel extending through the compressed gas cartridge engaging part adjacent to and separate from the piercing member channel.

17. An inflator head according to claim 13, wherein the one or more gas flow channels extend through the compressed gas cartridge engaging part adjacent to and separate from the piercing member channel.

18. An inflator head according to claim 13, wherein the valve engaging part and the compressed gas cartridge engaging part are integrally formed.

19. An inflator head according to claim 13, wherein the valve engaging part and the compressed gas cartridge engaging part are fluidly connected by a flexible tube.

20. An inflator head according to claim 13, wherein a gas flow through the inflator head follows an equivalent path when the inflator head is used with the pump and when the inflator head is used with the compressed gas cartridge.
